(19) United States
(12) Patent Application Publication
(10) Pub. No.: US 2021/0158450 A1
(43) Pub. Date: May 27, 2021

(54) METHOD FOR COUPLING TRUSTED TRANSMISSIONS TO AUTOMATED ENROLLMENT PROCESS

(71) Applicant: STATE FARM MUTUAL AUTOMOBILE INSURANCE COMPANY, Bloomington, IL (US)

(72) Inventors: Timothy Joel Davis, Bloomington, IL (US); Greg Maurer, Sachse, TX (US)

(73) Assignee: STATE FARM MUTUAL AUTOMOBILE INSURANCE COMPANY, Bloomington, IL (US)

(21) Appl. No.: 15/411,668

(22) Filed: Jan. 20, 2017

Related U.S. Application Data
(60) Provisional application No. 62/288,004, filed on Jan. 28, 2016.
(60) Provisional application No. 62/289,969, filed on Feb. 2, 2016.

(51) Int. Cl. G06Q 40/08; G06Q 30/02

(52) U.S. Cl. CPC G06Q 40/08; G06Q 30/0207

(57) ABSTRACT

A computer-implemented method for applying a discount during an automated insurance enrollment process. A prompt may be transmitted to and presented on the consumer's computing device display to gauge whether the consumer is interested in being redirected for consideration of a qualifying purchase linked to discount or other offer. An affirmative response may be received to the prompt and the consumer may be redirected to information relating to the qualifying purchase via an acquisition module. A trusted transmission may be received that indicates that a qualifying purchase is, or will be, made by the consumer. A discount linked to the qualifying purchase may be applied before completing the insurance enrollment. For instance, an online applicant for homeowners insurance may be offered a discount if they purchase a security system, and redirected online to a preferred security system provider, and after online purchase of the security system, be provided a discount.

### RELATED APPLICATIONS

The current patent application is a non-provisional patent application which claims priority benefit with regard to all common subject matter to U.S. Provisional Application Ser. No. 62/288,004, titled “METHOD FOR COUPLING TRUSTED TRANSMISSIONS TO AUTOMATED ENROLLMENT PROCESS”, filed Jan. 28, 2016; and U.S. Provisional Application Ser. No. 62/289,969, titled “METHOD FOR COUPLING TRUSTED TRANSMISSIONS TO AUTOMATED ENROLLMENT PROCESS”, filed Feb. 2, 2016. The listed earlier-filed provisional applications are hereby incorporated by reference in their entireties into the current patent application.

### FIELD

The present disclosure generally relates to computer-implemented methods, computer programs, computer servers, and computer-readable media for coupling trusted transmissions to an automated insurance enrollment process.

### BACKGROUND

In the insurance industry, discounts on premiums may be offered to consumers who meet certain qualifications. For homeowner's insurance, examples of the qualifications may include possessing a security system, the implementation of fire alarms, fire extinguishers, and/or sprinklers throughout the house.

In order to verify that the qualifications have been properly met, insurance providers may request that the consumer's agent contact the consumer to contact the person or entity who may provide the verification. The entities who may provide verification may include vendors who sell the products mentioned above, contractors who install them, inspectors who check the installation, and so forth. The verification may include documents, forms, or statements that cover the purchase or installation of the security and safety products.

Insurance may be acquired by consumers through online channels. However, conventional online channels may be ineffective where a consumer does not already satisfy discount qualification(s) at the beginning of the enrollment process. Therefore, there remains a need for an improved method for issuing discounted insurance policies through online channels.

### BRIEF SUMMARY

Embodiments of the present technology relate to computer-implemented methods, computer programs, computer servers, and computer-readable media for coupling trusted transmissions to an automated insurance enrollment process. In one embodiment, a computer-implemented method may be implemented through a website environment or mobile application, and may be initiated upon receipt of a consumer enrollment request. The method may include transmitting a prompt to be presented on a consumer's computing device display to gauge whether the consumer is interested in being redirected for consideration of at least one qualifying purchase linked to at least one discount. The method may further include receiving an affirmative response to the prompt and redirecting the consumer to information relating to the at least one qualifying purchase via an acquisition module. The method may still further include receiving a trusted transmission of a trusted transmission type, the trusted transmission indicating that a qualifying purchase is or will be made by the consumer. Yet still further, the method may include applying a discount linked to the qualifying purchase before completing the insurance enrollment. The method may include additional, fewer, or alternative steps, including those discussed elsewhere herein.

In one aspect, a computer-implemented method for coupling trusted transmissions to automated insurance enrollment may be provided that includes determining a discount and matching a qualifying purchase with the discount. The method may include defining at least one trusted transmission type indicative of the qualifying purchase. The method may include configuring an automated insurance enrollment computer program to automatically apply the discount if a transmission of the at least one trusted transmission type is received. The automated insurance enrollment computer program may further be configured to automatically receive consumer enrollment selections over a communication network, and to automatically complete an enrollment process based upon the enrollment selections and/or on pricing data stored in a memory device. The method may include additional, fewer, or alternative steps, including those discussed elsewhere herein, and may be implemented via one or more local or remote processors.

In another aspect, a computer-implemented method for coupling trusted transmissions to automated insurance enrollment may be provided that includes determining a qualifying purchase matched to a discount. The method may include configuring an automated insurance enrollment computer program to automatically launch an acquisition module, the acquisition module being configured to assist the consumer in making the qualifying purchase. The automated insurance enrollment computer program may further be configured to automatically receive, over a communication network, consumer enrollment selections and at least one trusted transmission of a trusted transmission type indicative of the qualifying purchase, and to automatically complete an enrollment process based upon the enrollment selections, the trusted transmission, and/or on pricing data stored in a memory device. The method may include additional, fewer, or alternative steps, including those discussed elsewhere herein, and may be implemented via one or more local or remote processors.

In another aspect, an improved computer-implemented method may be provided for automatically completing an insurance enrollment process based upon consumer enrollment selections and on pricing data stored in a memory device. The improvement in the method may include executing an acquisition module. The acquisition module may be configured to redirect a consumer to one or more pre-determined destinations selected to enable the consumer to perform at least one of the following: (A) select a vendor from which to make a qualifying purchase, and (B) make a qualifying purchase. The acquisition module may be configured to evaluate a transmission to determine if it satisfies a trusted transmission type, the trusted transmission type indicating that a qualifying purchase is or will be made by the consumer. The acquisition may further be configured to generate a signal indicating that the transmission is a trusted transmission if the transmission satisfied the trusted transmission type. The method may include additional, fewer, or alternative steps, including those discussed elsewhere herein, and may be implemented via one or more local or remote processors.

In another aspect, a computer-implemented method may be provided for improving automated insurance enrollment that includes providing a post-enrollment analysis agent. For example, the method may include providing a consumer profile database including data relating to a plurality of completed enrollment processes managed by an automated insurance enrollment program. The data may include post-enrollment information regarding at least one of (A) claims activities, and (B) transmissions. The method may include providing a post-enrollment analysis agent that automatically interfaces with the consumer profile database to periodically and automatically reconfigure at least one aspect of the automated insurance enrollment program. The post-enrollment analysis agent may independently analyze the consumer profile database to determine a first common variable that is found in a plurality of the enrollment processes and that arose prior to completion of each of the enrollment processes. The post-enrollment analysis agent may analyze the consumer profile database to determine a second common variable of the plurality of the enrollment processes that arose following completion of each of the enrollment processes. Further, the post-enrollment analysis agent may determine a correlation between the first common variable and the second common variable, and change at least one of pricing data and the configuration of the automated insurance enrollment program based upon the correlation. The method may include additional, fewer, or alternative steps, including those discussed elsewhere herein, and may be implemented via one or more local or remote processors.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of methods and computer servers disclosed therein. It should be understood that each Figure depicts an embodiment of a particular aspect of the disclosed methods and computer servers, and that each of the Figures is intended to accord with a possible embodiment thereof. Further, wherever possible, the following description refers to the reference numerals included in the following Figures, in which features depicted in multiple Figures are designated with consistent reference numerals. The present embodiments are not limited to the precise arrangements and instrumentalities shown in the Figures.

FIG. 1 illustrates an exemplary environment in which various embodiments of a computer server, configured to coupling trusted transmissions to automated insurance enrollment, may operate, the exemplary environment including a communication network that allows communication with various computing devices and third parties such as vendors, contractors, and appraisers;

FIG. 2 illustrates various exemplary components of the computer server shown in block schematic form;

FIG. 3 illustrates an analysis class diagram showing embodiments of the system incorporating a post-enrollment analysis agent for independent monitoring and adjustment of an insurance enrollment process;

FIGS. 4A to 4C illustrate at least a portion of an exemplary computer-implemented method for coupling trusted transmission to automated insurance enrollment; and

FIG. 5 illustrates at least a portion of an exemplary computer-implemented Home Alert cross-sell method.

The Figures depict exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments described in this patent application and other possible embodiments address a computer-centric challenge or problem with a solution that is necessarily rooted in computer technology and may relate to, inter alia, methods and computer servers for coupling trusted transmissions to automated insurance enrollment. A consumer, such as either a potential new consumer or an existing consumer, may visit a website operated by an insurance provider to apply for an insurance policy and/or to change the scope of an already existing insurance policy. Software executed on the website server may receive an enrollment request from the consumer. The enrollment request may consist of a consumer input received at the server that indicates a desire to begin an automated enrollment process coordinated by server software. The enrollment process may have as its goal(s) completion of initial policy acquisition and/or a change of scope for an existing policy.

The server software may transmit one or more prompts that ask the consumer whether their home includes various safety or security products such as a security system, fire alarms, fire extinguishers, sprinklers, dead bolt locks, and the like. Such prompt(s) may relate to associated services, such as various degrees of monitoring, alert, security response and similar services. Another prompt may ask the consumer about architectural or structural features of the house, such as the type of material used for the roof of the house, whether renovations have been made recently (within the past year), and so forth. Another prompt may inquire as to less tangible or less permanent security features associated with the property and/or with individual occupants, such as personal security devices or the like, and/or to any associated services.

Where material, for example with respect to life or health insurance policies, additional prompts may gather information regarding devices, such as workout equipment or health data tracking devices and/or any associated services. Where automobile insurance is contemplated, one or more prompts may also gather information regarding car alarms, self-driving features, or similar features and/or associated services that may reduce the risk of harm and/or damage associated with such vehicle(s).

It should be appreciated that the foregoing products and services are illustrative of a general class of products and services that, if consumed by a consumer, are considered likely to benefit an insurance provider by reducing risk arising from issuance of one or more insurance policies. Such products and services may be referred to herein as “qualifying” products and services that may be eligible for a discount or other pecuniary consideration for the consumer's possession or likely possession, and/or use or likely use, in a manner that may reduce risk to the insurance provider.

If the consumer answered yes to any of the inquiries described immediately above or elsewhere herein, then the server software may issue a prompt to the consumer requesting permission for the insurance provider to request confirmation from a relevant third party. For example, if the consumer responded that their house or car includes one or more of the safety and security products, then a prompt issued by the server software may ask the consumer to provide contact information about the vendor who sold the safety or security product, and to grant permission to contact the vendor (to retrieve verifying information from the vendor with consumer permission or affirmative consent). Alternatively or additionally, if the consumer responded that their house or car includes one or more of the safety and security products, then a prompt may ask the consumer to provide contact information about the contractor who installed the product, and to grant permission to contact the contractor (to retrieve verifying information from the contractor with customer permission or affirmative consent).

Similarly, if the consumer responded that their house has impact-resistant roofing material or that they had renovations done recently, then a prompt may ask the consumer to provide contact information about the contractor who installed the material or made the renovations, and to grant permission to contact the contractor. If the consumer responded that they own and/or use a personal device or service, such as a health tracking or personal security device or the like, a prompt may ask the consumer to provide contact information about the seller of such device and/or provider of related subscription service(s).

If the consumer responded “no” to all of the inquiries and/or if the server software otherwise identifies a qualifying product/service that the consumer may not have, then the software may issue a prompt informing the consumer that they may be eligible for a discount on their insurance premium if they purchase, install and/or otherwise receive certain safety, security or health-related products and/or services. For example, the software may suggest a security system with specific features or a variety of optional features, or certain security system models that qualify for the discount, types of door locks, types of fire alarms, fire extinguishers, and sprinklers, and so forth. The server software may also inform the consumer that architectural or structural improvements to the house, including a new roof with certain impact-resistant materials, may lead to a discount on their insurance premium. The software may likewise inform the consumer about other qualifying products and/or services. In response, the consumer may provide an affirmative reply to the prompt regarding such qualifying products and services, indicating an interest in exploring such potential purchase(s) further.

In other aspects, an acquisition module may be executed on a vendor's website server—for example in response to the consumer's affirmative reply to a prompt inquiring about interest in exploring a qualifying purchase—to redirect the consumer to one or more pre-determined destinations intended to assist the consumer in acquiring one or more qualifying products and/or services, otherwise referred to as making a “qualifying purchase.” The acquisition module preferably comprises a section of an automated insurance enrollment program, together forming a segment of the server software.

In one embodiment, the acquisition module will access a list of pre-determined destinations, sorted for example based upon insurance policy type, preferred vendor statuses, and/or potential discount amount for particular qualifying product/service(s), to determine at least one pre-determined destination for presentation to the consumer. Such a pre-determined destination may be a webpage operated by a vendor who sells qualifying safety and security products.

Following redirection of the consumer, the enrollment program may remain suspended, pending passage of a pre-defined time period and/or occurrence of a pre-determined event type, to allow the consumer adequate time to complete a qualifying purchase. The acquisition module may further be configured to receive a transmission and evaluate it to determine if it satisfies certain pre-determined criteria (together comprising a “trusted transmission type”) indicating with trustworthiness that the qualifying purchase was completed. The enrollment program and/or acquisition module may then inform the consumer that they might be, or are entitled to, a discount on their insurance premium because of such purchase. The enrollment program and/or acquisition module may further be configured to require that a second trusted transmission be received, for example indicating that installation and/or activation of a purchased qualifying product has been completed, before a discount is finalized and/or to ensure it is not withdrawn after initially being granted.

Preferably, the enrollment program and acquisition module are implemented in conjunction with a post-enrollment analysis agent. The post-enrollment analysis agent may be configured to independently observe certain post-enrollment data, to find correlations between the post-enrollment data and other data gleaned from historic enrollment records regarding completed purchases, and/or to adjust the operation and parameters of certain aspects of the enrollment program accordingly.

For example, the post-enrollment analysis agent may continually or periodically assess the relationship between acceptance of a particular trusted transmission type during enrollment on the one hand, and actual use by the consumer of the qualifying product or service on the other hand. If the trusted transmission type in question is not a reliable indicator that a consumer will put the product or service to risk-reducing use, the post-enrollment analysis agent may disable acceptance of that transmission type for the qualifying purchase, supplement the discount granting portion of the enrollment process by requiring an additional trusted transmission, or make other suitable changes. For another example, by evaluating certain information about the consumer and/or qualifying product/service collected following completion of the enrollment process, the post-enrollment analysis agent may assess the accuracy of risk reduction presumptions underlying the discount(s) included in pricing data in order to adjust those discounts to be more reflective of the actual risk reduction benefits realized by the insurance provider.

Specific embodiments of the technology will now be described in connection with the attached drawing figures. The embodiments are intended to describe aspects of the invention in sufficient detail to enable those skilled in the art to practice the invention. Other embodiments may be utilized and changes may be made without departing from the scope of the present invention. The following detailed description is, therefore, not to be taken in a limiting sense. The scope of the present invention is defined only by the appended claims, along with the full scope of equivalents to which such claims are entitled.

### Exemplary Computer Server

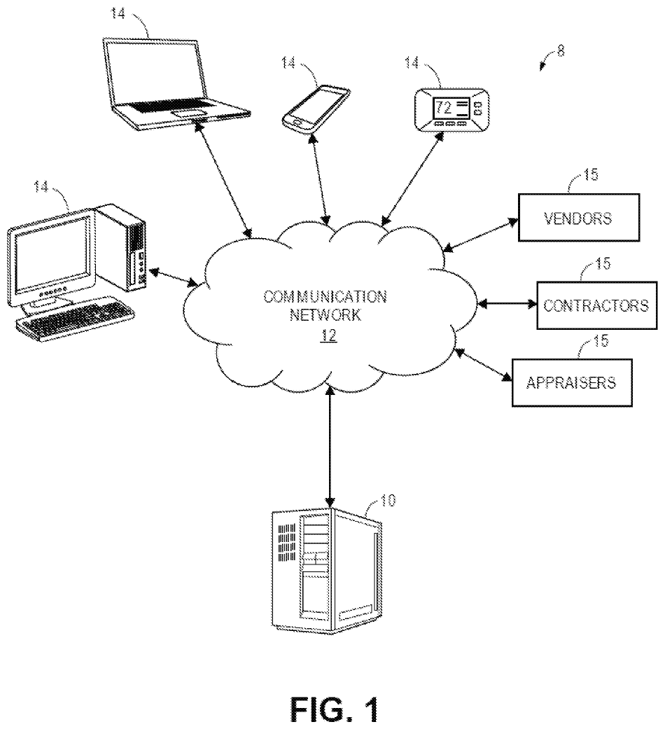

FIG. 1 depicts an exemplary system 8 in which embodiments of a computer server 10 may be utilized for coupling trusted transmissions to an automated insurance enrollment process. The environment may include a communication network 12 and a plurality of computing devices 14. Such computing devices 14 may include a desktop computer, a laptop or tablet computer, a smartphone, a telematics data device or “black box” mounted on a vehicle, a smart home controller, or similar devices. The communication network 12 may provide wired and/or wireless communication between the computing devices 14 and the computer server 10. Server 10 may host an insurance provider website. Server 10 and computing devices 14 may also communicate with various third party computer systems 15, such as those operated by vendors, contractors, and appraisers. A consumer may utilize a computing device 14 to access the insurance provider's website to sign up for a new insurance policy, to update information on and/or change the scope of a current insurance policy, or the like.

Each of computing devices 14 may be configured to send data to and/or receive data from one another and/or via network 12 using one or more suitable communication protocols, which may be the same communication protocols or different communication protocols as one another. To provide an example, computing devices 14 may be configured to communicate with one another via a direct radio link, which may utilize, for example, a Wi-Fi direct protocol, an ad-hoc cellular communication protocol, etc. Furthermore, computing devices 14 may be configured to communicate with vehicle on-board computers located in vehicles utilizing a Bluetooth® communication protocol (radio link not shown). One or more of computing devices 14 may also be configured to communicate with one or more smart components directly and/or indirectly using any suitable communication protocols and radio links.

In one aspect, each of computing devices 14 may be configured to communicate with one another directly via peer-to-peer (P2P) wireless communication and/or data transfer. In other aspects, each of computing devices 14 may be configured to communicate indirectly with one another and/or any suitable device via communications over network 12, such as server 10, for example. In still other aspects, each of computing devices 14 may be configured to communicate directly and indirectly with one and/or any suitable device, which may be concurrent communications or communications occurring at separate times.

In one aspect, computing devices 14 may be implemented within a vehicle or smart vehicle that may have an associated on-board computer. Each vehicle may be configured for wireless inter-vehicle communication, such as vehicle-to-vehicle (V2V) wireless communication and/or data transmission. In one embodiment, smart home controller 14 may be in wired or wireless communication with a home alarm system, plurality of processor/sensor pairs located about a home, and/or a home mounted sensor array. The sensors may generate or collect data, and transmit (via a transceiver) the data collected to the smart home controller 14 or to server 10 for further analysis. For instance, each home-mounted sensor may be in wireless RF communication with the smart home controller 14 or server 10 via one or more radio links that utilize an IEEE communication standard.

The communication network 12 generally also allows communication between the computing devices 14 and the computer server 10, such as via wireless communication and data transmission over one or more radio links. The communication network 12 may include local area networks, metro area networks, wide area networks, cloud networks, the Internet, cellular networks, plain old telephone service (POTS) networks, and the like, or combinations thereof. The communication network 12 may be wired, wireless, or combinations thereof and may include components such as modems, gateways, switches, routers, hubs, access points, repeaters, towers, and the like. The computing devices 14 may connect to the communication network 12 either through wires, such as electrical cables or fiber optic cables, or wirelessly, such as radio frequency (RF) communication using wireless standards such as cellular 2G, 3G, or 4G, Institute of Electrical and Electronics Engineers (IEEE) 802.11 standards such as WiFi, IEEE 802.16 standards such as WiMAX, Bluetooth™, or combinations thereof.

Network 12 may be implemented as any suitable network configured to facilitate communications between computing devices 14, server 10 and/or third party computer systems 15. For example, network 12 may include one or more telecommunication networks, nodes, and/or links used to facilitate data exchanges between one or more devices, and may facilitate a connection to the Internet for devices configured to communicate with network 12. Network 12 may include any suitable number of interconnected network components that form an aggregate network system, such as dedicated access lines, plain ordinary telephone lines, satellite links, cellular base stations, a public switched telephone network (PSTN), etc., or any suitable combination thereof. Network 12 may include, for example, a proprietary network, a secure public internet, a secure electronic communication network, a mobile-based network, a virtual private network, etc.

In aspects in which network 12 facilitates a connection to the Internet, data communications may take place over the network 12 via one or more suitable Internet communication protocols. For example, network 12 may be implemented as a wireless telephony network (e.g., GSM, CDMA, LTE, etc.), a Wi-Fi network (e.g., via one or more IEEE 802.11 Standards), a WiMAX network, a Bluetooth network, etc.

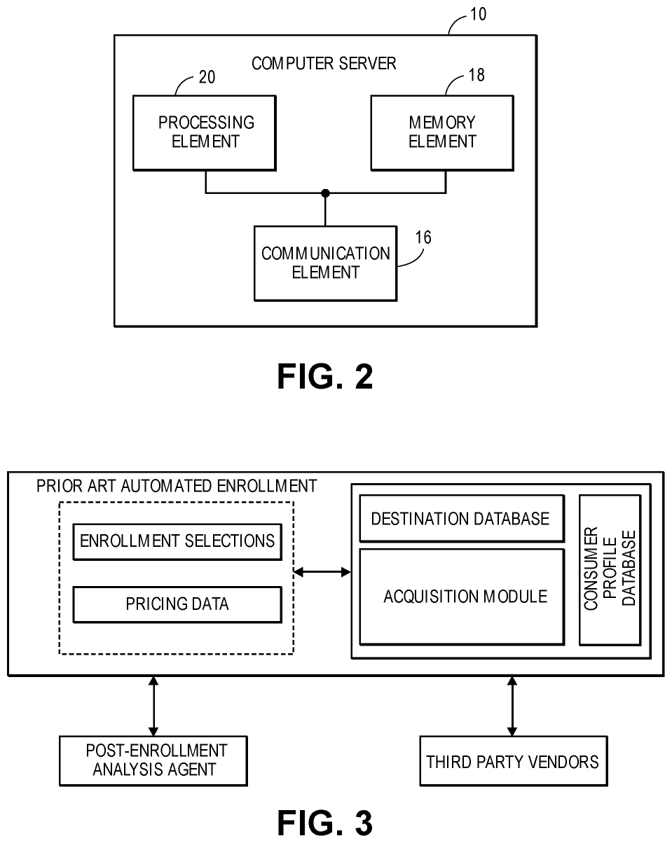

The computer server 10 generally retains electronic data and may respond to requests to retrieve data, as well as to store data. The computer server 10 may be embodied by application servers, database servers, file servers, gaming servers, mail servers, print servers, web servers, or the like, or combinations thereof. Furthermore, the computer server 10 may include a plurality of servers, virtual servers, or combinations thereof. The computer server 10 may be configured to include or execute software, such as file storage applications, database applications, email or messaging applications, web server applications, or the like. As indicated in FIG. 2, the computer server 10 may broadly comprise a communication element 16, a memory element 18, and a processing element 20.

The communication element 16 generally allows communication with external systems or devices, again such as via wireless communication and/or data transmission over one or more direct or indirect radio links between devices. The communication element 16 may include signal or data transmitting and receiving circuits, such as antennas, amplifiers, filters, mixers, oscillators, digital signal processors (DSPs), and the like. The communication element 16 may establish communication wirelessly by utilizing RF signals and/or data that comply with communication standards such as cellular 2G, 3G, or 4G, WiFi, WiMAX, Bluetooth™, and the like, or combinations thereof. In addition, the communication element 16 may utilize communication standards such as ANT, ANT+, Bluetooth™ low energy (BLE), the industrial, scientific, and medical (ISM) band at 2.4 gigahertz (GHz), or the like.

Alternatively, or in addition, the communication element 16 may establish communication through connectors or couplers that receive metal conductor wires or cables which are compatible with networking technologies, such as ethernet. In certain embodiments, the communication element 16 may also couple with optical fiber cables. The communication element 16 may be in communication with the processing element 20 and the memory element 18, again such as wireless communication and data transmission over one or more radio links.

The memory element 18 may include electronic hardware data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory element 18 may be embedded in, or packaged in the same package as, the processing element 20. The memory element 18 may include, or may constitute, a “computer-readable medium.” The memory element 18 may store the instructions, code, code segments, software, firmware, programs, applications, apps, modules, agents, services, daemons, or the like that are executed by the processing element 20. The memory element 18 may also store settings, data, documents, sound files, photographs, movies, images, databases, and the like.

The processing element 20 may include electronic hardware components such as processors, microprocessors (single-core and multi-core), microcontrollers, digital signal processors (DSPs), field-programmable gate arrays (FPGAs), analog and/or digital application-specific integrated circuits (ASICs), or the like, or combinations thereof. The processing element 20 may generally execute, process, or run instructions, code, code segments, software, firmware, programs, applications, apps, modules, agents, processes, services, daemons, or the like. The processing element 20 may also include hardware components such as finite-state machines, sequential and combinational logic, and other electronic circuits that can perform the functions necessary for the operation of the current invention. The processing element 20 may be in communication with the other electronic components through serial or parallel links that include address busses, data busses, control lines, and the like.

Through hardware, software, firmware, or combinations thereof, the processing element 20 may be configured or programmed to perform the following functions. The processing element 20 may execute code, such as hypertext markup language (HTML), Java, and so forth, to implement a website from an insurance provider. The website may present information about various policies and services offered by the insurance provider. The website may allow a potential new consumer to sign up for insurance coverage. The website may also allow an existing consumer to change or acquire a policy, submit a claim, and/or provide updated information after a move, a change in the family, renovation to the house, and the like. The consumer may execute a browser application on their computing device 14 that allows them to access the website on the computer server 10 in a generally known fashion.

When the consumer is seeking or updating a homeowner's insurance policy, for example, the processing element 20 may execute a software application or computer-implemented method as part of the website code or in addition to the website code. The software application is preferably configured to automatically manage and administer the various steps of an insurance enrollment process, and may be referred to as the “insurance enrollment program.” It is envisioned that all or a portion of the functions performed by the computer server 10 may be outsourced to the computing devices 14, preferably through execution of a mobile application for example, without departing from the spirit of the present inventive concept.

The insurance enrollment program is preferably triggered to begin or continue the enrollment process when it receives a consumer-generated enrollment request—for example a consumer-generated input resulting from mouse input resulting from selection of an option for proceeding with enrollment presented on a consumer display of the computing device 14. A consumer may communicate the desire to explore the enrollment process/options using the insurance enrollment program through other known mechanisms, such as through a keyboard input or the like, without departing from the spirit of the present inventive concept.

The processing element 20 may generate and transmit instructions, through the communication element 16 and the communication network 12 (e.g., over one or more radio links), to the computing device 14 that presents a prompt on the display of the computing device 14. The prompt may appear in a pop-up window or as part of a list or sequence of questions on a regular page of the website. The prompt may include questions regarding the home or other to-be-insured property. The prompt may also or alternatively provide information to the consumer. The prompt may ask the consumer if they have recently purchased and installed/used any safety, health and/or security-related products, services and/or devices. These products may include a security system, fire alarms, fire extinguishers, sprinklers, dead bolt locks, health monitoring devices, car alarms, or other qualifying products/services.

The processing element 20 may also generate and transmit another prompt, over the one or more radio links, that asks the consumer about architectural or structural features of the house, such as the type of material used for the roof of the house, whether renovations, such as remodeling or adding on to the house, have been made recently (within the past year), and so forth.

If the consumer answers yes to the purchase and installation of any safety, health and/or security-related products, specifies that impact-resistant material has been used on the roof or that renovations have recently been done, or otherwise indicates that a qualifying product/service has been obtained and/or is being used, then the processing element 20 may generate and transmit another prompt, for example over one or more radio links, for the consumer to grant permission to the insurance provider to request information from the relevant third party. For example, if the consumer responded that their house includes one or more of the safety and security products, then the processing element 20 may generate and transmit, over one or more radio links, another prompt to ask the consumer to provide contact information about the vendor who sold the safety or security product, and to grant permission to contact the vendor.

After receiving permission, the processing element 20 may then contact the vendor, through the communication element 16 and the communication network 12, such as via one or more radio links, and request documents that provide a proof of purchase, such as an invoice or a sales receipt. Alternatively or additionally, if the consumer specifically responded that their house includes one or more of the qualifying products/services, then the processing element 20 may generate and transmit, via one or more radio links, another prompt to ask the consumer to provide contact information about the contractor who installed the product, and to grant permission to contact the contractor. After receiving permission, the processing element 20 may then contact the contractor and request documents (e.g., over one or more radio links), such as an invoice or receipt for the installation, or a statement from the contractor attesting that he installed the safety or security product.

If the consumer responds that their house has impact-resistant roofing material or that they had renovations done recently, then the processing element 20 may generate and transmit, via one or more radio links, another prompt to ask the consumer to provide contact information about the contractor who installed the material or made the renovations, and to grant permission to contact the contractor. After receiving the information and permission, the processing element 20 may then, over one or more radio links, contact the contractor and request documents, such as a contract, invoice, or receipt for the work, or a statement from the contractor attesting that he performed the installation or renovation.

The processing element 20 may also access and/or generate a list of one or more qualifying products/services with respect to the insurance type(s) the consumer is investigating in the enrollment process. The processing element 20 may generate and transmit, preferably via wireless communication (or data transmission) and using one or more radio links, another prompt to inform the consumer that they may be eligible for a discount on their insurance premium if they purchase and/or install, and/or use such qualifying product(s)/service(s). Preferably, the qualifying product(s)/service(s) offered for consideration by the consumer do not include those specific product(s)/service(s), if any, that the consumer may have already indicated they own or enjoy in previous steps described above except to the extent that redundant product(s)/service(s) may also reduce potential risk to the insurance provider, and thus comprise qualifying purchase(s).

For example, the processing element 20 may generate and transmit a prompt to suggest a security system with specific features, or certain security system models that qualify for the discount, types of door locks, types of fire alarms, fire extinguishers, and sprinklers, and so forth. In various embodiments, the processing element 20 may generate and transmit another prompt to further suggest approved vendors or manufacturers of safety and security products. The processing element 20 may also generate and transmit another prompt to inform the consumer that architectural or structural improvements to the house, including a new roof with certain impact-resistant materials, may lead to a discount on their insurance premium.

Preferably, an option to be redirected to at least one destination, such as one or more webpage(s) or mobile application(s), may be presented to the consumer. The option may be presented by the processing element 20 in the prompt described in the preceding paragraph and/or in a separate prompt. Preferably, the prompt, its contents and delivery, are managed at least in part by an acquisition module. The acquisition module is that section of the insurance enrollment program responsible for redirecting consumers from and to the insurance provider's website during the enrollment process in connection with exploring and/or purchasing qualifying product(s)/services.

Each destination offered to the consumer by the acquisition module preferably contains information relating to and/or means to complete at least one qualifying purchase for one or more discount(s) offered by the insurance provider. For example, the consumer may be offered a list of vendors that sell and/or lease such qualifying product(s)/service(s). The consumer may also or alternatively be offered a list of qualifying product(s)/service(s) and/or groupings thereof from which the consumer can choose. The destinations offered to the consumer and their order/prioritization may be chosen by the acquisition module based upon commonly-employed prioritization techniques taking into account, for example, consumer or industry reviews and ratings, breadth of product offerings, price competitiveness, and other aspects of the product(s)/service(s) and/or vendors that commonly govern in analogous Internet shopping scenarios. In addition, the operation of the acquisition module, including its functions of populating and/or ordering/prioritizing the destinations offered to the consumer, are preferably adjusted on a periodic basis by a post-enrollment analysis agent, described in additional detail below. In addition, the destinations are preferably pre-determined prior to a consumer's affirmative response to a redirect prompt as described above, for example to reduce any response and redirection delay.

If a consumer responds affirmatively to the prompt, for example by selecting one or more product(s), service(s) and/or vendor(s) or otherwise expressing interest in a qualifying purchase, the acquisition module preferably issues instructions through processing element 20 and communication element 16 for the consumer's browser to be redirected to at least one of the destination(s). The destination(s) may be operated and/or hosted by a third party, for example a third party vendor, by server 10, or by another insurance provider server. In some embodiments, the enrollment session the consumer is participating in on the server 10 may be suspended following redirection. Suspending the enrollment session may include automatically saving all information gathered to that point in the enrollment process, and/or flagging digital files associated with the enrollment process so they are readily retrievable when one or more events occur to signal the enrollment process has again become active.

Throughout the enrollment process, server 10 has preferably gathered or otherwise has access to a variety of information regarding the consumer(s). Information generated through interactions with the consumer(s) may be stored in a customer profile database. In addition, the insurance enrollment program preferably is configured to instruct processing element 20 to gather as much basic information regarding the consumer as possible from accessible databases—for example the consumer's age, income level, family status, residence, history of insurance claims, and other risk factors relating to the insurance type the consumer is seeking—and to prompt the consumer to provide pertinent information that may be missing from such databases. This collection of basic, insurance-related information regarding the consumer that is accessible to the enrollment program may be saved in the consumer profile database, which may be updated from time to time including as a result of enrollment process(es), receipt of post-enrollment transmissions, occurrence of qualifying purchase(s) and/or claims. The consumer profile database may also be supplemented using sources of public information, such as news outlets and/or criminal record databases, without departing from the spirit of the present inventive concept.

The insurance enrollment program is preferably configured to receive, via communications element 16, one or more transmissions from third party vendor systems 15. The insurance enrollment program, and preferably its acquisition module, may also be configured to instruct processing element 20 to extract and/or recognize information regarding the transmission(s) and to evaluate that information. Information regarding the transmission(s) may be provided in metadata associated with the transmission(s), may be extracted through optical character recognition, or may be obtained through other known means of retrieving similar information. For example, the transmission may include an image of a receipt evidencing completion of a qualifying purchase. Information regarding same may be obtained by recognizing metadata summarizing the contents of the receipt, or may be extracted through execution of optical character recognition software by the processing element 20.

Preferably, the processing element 20 may also evaluate information regarding the transmission. Such evaluation may include determining which product(s) or service(s) the transmissions relate to, and determining whether such product(s) or service(s) are “qualifying” in any respect, for example by comparison against a list of discount—product/service pairings included in pricing data stored on memory element 18. Such evaluation may also include identifying one or more consumers associated with the purchase(s), for example through explicit identification/means of submission by the third party vendor originating the transmission or from information recognition and extraction procedures identified above. Preferably, the evaluation will further include identification of pending enrollment process(es), from enrollment records, of identified consumers that may be affected by the information obtained from the transmission.

Preferably, the insurance enrollment program also instructs the processing element 20 to identify one or more “trusted transmission type(s)” based upon the information identified and obtained by the insurance enrollment program according to the procedures identified above. For example, for each discount—product/service pairing that may be pursued by a consumer, at least one trusted transmission type may be pre-determined as providing acceptable evidence on which to justify issuance of the discount.

A trusted transmission type comprises a set of characteristics that, if present in a particular transmission, indicate that it is more trustworthy. A trusted transmission type may be tailored for specific discount—product/service pairings and may also be tailored for specific consumer(s), for example by taking into account historical evidence of prudence, vigilance or the like with respect to the consumer(s). A type may require that each characteristic considered be present at least to some extent in the transmission, or the characteristics may alternatively be considered in a weighted summation or the like to determine whether, when added together, the various characteristics of a transmission show it should be trusted.

The characteristics that make up a trusted transmission type preferably include: whether the transmission was from a trusted source as evidenced by metadata, a source database or IP address; whether the transmission was transmitted via a trusted digital medium and/or in a trusted (i.e., encrypted) format; the type of event signified by the information obtained from the transmission (e.g., whether a product was purchased, installed, activated, etc.); and the type of document included with the transmission (e.g., sales receipt, service appointment receipt, confirmation of installation, active monitoring or subscription services record, etc.). A trusted transmission type may require that each characteristic must be met to at least some degree. A trusted transmission type may also be in the form of a weighted summation, for example to permit certain characteristics to compensate for lack of others, such as where a very trusted database source is permitted to compensate for a failure to encrypt the content of a transmission.

The insurance enrollment program preferably also instructs the processing element 20 to evaluate a transmission against the one or more relevant trusted transmission types identified for the pending enrollment process(es) of implicated consumer(s). Where the transmission does not satisfy a trusted transmission type, the insurance enrollment program preferably instructs processing element 20 to send a notification to the affected consumer(s), for display on at least one computing device 14, notifying them that a transmission was received regarding a potential qualifying purchase, but that the discount was not authorized based upon the transmission. Preferably, the notification also includes suggested “next steps” the consumer(s) might take to generate a transmission that might address the failure of authorization, or to otherwise attain the discount in question.

Where the transmission does satisfy a trusted transmission type, the insurance enrollment program preferably instructs the processing element 20 to apply the resulting discount to the implicated pending enrollment process(es) and to notify the affected consumer(s) of same. Preferably, the insurance enrollment program also instructs the processing element 20 to periodically check the status of pending enrollment processes, for example following success or failure of a transmission to meet “trusted” criteria, to determine whether the enrolling consumer(s) have reached final disposition on all indications of interest in making qualifying purchases. The processing element 20 may also check the customer profile database to determine whether any of the indications of interest are aged, and/or if a certain number of transmissions have failed to receive “trusted” status to allow a discount to be applied.

The insurance enrollment program may instruct processing element 20 to prompt the user to complete a pending enrollment process, or may instruct the automatic completion of the enrollment process, based upon the preferences of the user and the status of all outstanding indications of interest in making qualifying purchases. For example, a consumer may have indicated an interest in pursuing three qualifying purchases in connection with discounts for a policy under a pending enrollment process. The consumer may have completed one qualifying purchase that has been verified by a trusted transmission, with a discount having been applied as a result thereof, but the other two qualifying purchases for which interest was expressed are deemed “aged” through lack of related activity over several weeks. In such cases, the insurance enrollment program may instruct processing element 20 to prompt the user to complete the pending enrollment process on the basis of the discount that was applied. Preferably, the user enrollment request is received, the qualifying purchase is completed and confirmed by the trusted transmission, and the insurance enrollment process is completed, all in the same enrollment session.

Following completion of an enrollment process, the insurance enrollment program preferably instructs processing element 20 to close the associated enrollment record. The insurance enrollment program may, in certain circumstances, associate an additional contingency with such an enrollment record. The additional contingency may be required for maintaining a discount applied during the pendency of the enrollment process. For example, a homeowner's insurance policy may have had a discount applied for qualifying purchase and use of a security alarm. The discount may be initially applied based upon a first trusted transmission satisfactorily evidencing the qualifying purchase. The additional contingency may, however, require receipt of a post-enrollment, second trusted transmission from a contractor evidencing installment of the alarm system and/or from a monitoring service provider evidencing that the system is regularly being put to use. In some cases, such as where the discount and/or additional contingency requires proof of consistent use of a qualifying product or service, the first and/or second trusted transmission may be received from a computing device 14, such as a smart home controller or telematics data device, without departing from the spirit of the present inventive concept.

The additional contingency may be time sensitive (e.g., transmission confirming installation must occur within one month or the discount will be withdrawn), or event based (e.g., an additional discount will be applied upon receipt of evidence from a monitoring service provider showing consistent use at a certain level). Based upon the type of additional contingency, the processing element 20 may cause application of such discount changes and/or generate notifications to the consumer(s) regarding same on a periodic or event-based schedule.

FIG. 3 illustrates logical relationships between software and database components of a system according to the present inventive concept, and is not intended to convey structural relationships such as where such software and database components physically reside or are executed. In accordance with the illustration of FIG. 3, it is known to receive certain basic user enrollment selections (i.e., insurance type and property valuation) and rely on static pricing data (i.e., premium payments associated with each level and type of coverage) associated with one or more types of insurance policies to complete an online insurance enrollment process. However, the present inventive concept preferably additionally includes a destination database relied on by an acquisition module to redirect consumers according to the description above, as well as a consumer profile database providing a rich source of information regarding pre- and post-enrollment activities, and additional information accessible to or gathered by the enrollment program.

In addition, it is preferable to deploy a post-enrollment analysis agent for use in conjunction with the insurance enrollment program to provide an improved method of coupling trusted transmissions to the automated enrollment process. The post-enrollment analysis agent is preferably executed independently from the standard routines of the enrollment program that manage the enrollment process, in order that the agent may independently monitor, evaluate, and adjust the parameters of the enrollment program and/or the values stored in system databases. However, the post-enrollment analysis agent may be stored in memory element 18, and/or executed by and/or may provide instructions to processing element 20, without departing from the spirit of the present inventive concept.

The post-enrollment analysis agent preferably monitors and evaluates pre-enrollment and post-enrollment activities relating to consumers' insurance policies. The post-enrollment analysis agent may interface with the consumer profile database, and may also receive data directly from communication element 16. Specifically, the post-enrollment analysis agent preferably has access to claims information and post-enrollment transmissions, as well as to a variety of other information gathered into the consumer profile database by processing element 20, as described in additional detail above. Additionally, the post-enrollment analysis agent should have access to basic information gathered during the pendency of enrollment processes. For example, the consumer profile database may contain information regarding: consumers, gathered through and/or in connection with enrollment processes managed by the automated insurance enrollment program; user selections made during such enrollment processes; conclusions/selections arrived at by the insurance enrollment program throughout such enrollment processes; trusted transmissions received during and after completion of such enrollment processes; vendors and/or pre-determined destinations presented to and/or selected by consumers; qualifying purchases and/or qualifying products/services presented to and/or selected by consumers; location-based facts pertinent to risk analyses for areas policies are issued in connection with; claims entered in connection with insurance policies, and other pertinent information.

The consumer profile database therefore may include information gathered in connection with enrollment processes arising prior to completion of such processes (i.e., enrollment selections, trusted transmissions verifying qualifying purchases, vendors and/or pre-determined destinations used and/or offered, qualifying purchase(s), and the like). The consumer profile database also preferably includes information relating to such enrollment processes arising after their completion (i.e., claims submitted by the consumers, transmissions submitted in connection with such consumers, for example to verify installation/use of a product acquired through a qualifying purchase, and the like). Raw information regarding post-enrollment activities may be processed—for example using machine-learning and optical character recognition techniques discussed in additional detail below—to distill meaningful data therefrom, such as by determining a rate of conversion to intended use, and/or average realized risk reduction from such raw information, each of which may serve as a second common variable.

The post-enrollment analysis agent may instruct the processing element 20 periodically to access the consumer profile database to determine a first variable common to a plurality of enrollment processes that arose prior to their completion. The post-enrollment analysis agent may also instruct the processing element 20 to determine a second variable common to the plurality of enrollment processes that arose following their completion. Preferably, the post-enrollment analysis agent is initially provided a set of possible first common variables along with a set of possible second common variables, together with a relational data set identifying or mapping known correlations between first and second common variables, and/or groups of first common variables and groups of second common variables. These variable and relational data sets may be updated from time to time by system administrators and/or through machine-learning techniques discussed in further detail below.

Following selection of a first common variable and a second common variable, a correlation between the first common variable and the second common variable may be determined. For example, where a particular qualifying product, service, vendor or trusted transmission contributed to application of a discount prior to completing enrollment, it may be determined that an uncharacteristically low rate of conversion to intended use and/or realized risk reduction is realized by such consumers. Based thereon, the post-enrollment analysis agent may determine that the risk-reduction benefit assumptions underlying the applied discount no longer hold true. However, any correlation identified by the post-enrollment analysis agent is preferably screened before such a conclusion is reached, for example to ensure that the sample size is sufficient, the correlation is sufficiently longstanding, the standard deviation is sufficiently minimal, and that other similar indicators of accuracy are present.

Where the exemplary correlation described above has been found, screened and vetted for reliability and accuracy, the post-enrollment analysis agent may instruct the processing element 20 to reduce the discount amount represented in pricing data relied on by the insurance enrollment program. Alternatively or in addition, the post-enrollment analysis agent may instruct the processing element 20 to reconfigure the enrollment program by: changing trusted transmission type(s) permitted to verify qualifying purchase(s); changing the timeframes in which and/or periodicity with which trusted transmissions are required to be provided/confirmed; changing the number of trusted transmissions that are required to be provided/confirmed; adding/removing/re-ordering vendor and/or pre-determined destination listings used by the acquisition module to redirect users; changing the qualifying purchase(s), and other similar changes that may be expected to lead to completed enrollment processes reflective of the risk likely to be experienced by the insurance provider.

It should be appreciated that the foregoing description is merely illustrative, and that any pairing of first and second common variables, and/or any combination of first common variables paired with a combination of second common variables, may be analyzed and evaluated according to known data analysis techniques to determine reliable correlations therebetween, without departing from the spirit of the present inventive concept.

### Exemplary Machine Learning

The processing element 20 may utilize machine learning programs or techniques. For instance, the processing element 20 may utilize the information from the post-enrollment claims and trusted transmission information collected, and apply that data to one or more machine learning techniques to generate one or more correlations or other relational observations. The processing element 20 and/or machine learning techniques may therefore recognize or determine patterns and/or inconsistencies between actual data collected after enrollment on the one hand, and the assumptions underlying discount pricing and/or the functions of the acquisition module on the other hand. The machine learning techniques or programs may include curve fitting, regression model builders, convolutional or deep learning neural networks, combined deep learning, pattern recognition, or the like. Based upon this data analysis, the processing element 20 and/or machine learning techniques may generate new discount or pricing data and/or instructions for operation of the acquisition module of the automated enrollment program.

Machine learning may involve identifying and recognizing patterns in existing data in order to facilitate making predictions for subsequent data. Models may be created based upon example inputs in order to make valid and reliable predictions for novel inputs. In supervised machine learning, the processing element 20 may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element 20 may be required to find its own structure in unlabeled example inputs. In one embodiment, machine learning techniques may be used to extract the relevant personal and/or health-related information for insurance applicants from images and/or voice recordings of those applicants without needing to acquire samples of bodily fluids or conduct conventional medical reviews.

The processing element 20 may employ a neural network, which may be a convolutional neural network (CNN) and/or a deep learning neural network. A CNN is a type of feed-forward neural network often used in facial recognition systems, in which individual neurons may be tiled so as to respond to overlapping regions in the visual field. A CNN may include multiple layers of small neuron collections which examine small portions of an input image, called receptive fields. The results of these collections may be tiled so that they overlap to better represent the original image, and this may be repeated for each layer. Deep learning involves algorithms that attempt to model high-level abstractions in data by using model architectures, with complex structures or otherwise, composed of multiple non-linear transformations. An image may be represented in various ways, such as a vector of intensity values per pixel, a set of edges, or regions of particular shape. Certain representations may better facilitate learning how to identify personal and health-related information from examples.

The foregoing machine learning techniques may be configured to determine adjustments that may improve the conduct of the automated enrollment process so that it better reflects realized risk to the insurance provider. In this sense, the post-enrollment analysis agent improves process reliability through improving steps of the automated process so that it more closely approximates the risk/reward proposition realized by the insurance provider through analysis of post-enrollment data.

In addition, the processing element 20 and/or machine learning techniques may be employed to gather and analyze additional information pertinent to risk profiles for individual consumers. Consumer risk profiles of this type may be centered in conventional risk analysis—that is, by directly assessing the risk presented by individual consumers—as compared with process reliability analyses performed by the post-enrollment analysis agent and described above. The processing element 20 and/or machine learning techniques may utilize the risk profile in combination with information regarding features of the property to be insured to determine a level of risk for the property.

As noted, data gathered by processing element 20 may be input into a machine learning program. The machine learning program may include curve fitting, regression model builders, convolutional or deep learning neural networks, pattern recognition, or the like. Based upon patterns of activity and/or the presence of certain conditions or the occurrence of certain events, the machine learning program may calculate or estimate a level of risk for a property to be insured. In one embodiment, based upon the level of risk, or an adjusted risk profile, a premium or discount may be calculated.

### Exemplary Machine Learning Embodiments

In one aspect, a computer-implemented method for improving automated insurance enrollment may be provided. The method may include providing a consumer profile database including data relating to a plurality of completed enrollment processes managed by an automated insurance enrollment program. The data may include post-enrollment information regarding at least one of (A) claims activities, and (B) transmissions. The method may include providing a post-enrollment analysis agent that automatically interfaces with the consumer profile database to periodically and automatically reconfigure at least one aspect of the automated insurance enrollment program. The post-enrollment analysis agent may independently analyze the consumer profile database—for example, by inputting the database data into a machine learning program (and/or object recognition, facial recognition, or optical character recognition programs)—to determine a first common variable that is found in a plurality of the enrollment processes and that arose prior to completion of each of the enrollment processes. The post-enrollment analysis agent may also analyze the consumer profile database—for example, by inputting the database data into a machine learning program (and/or object recognition, facial recognition, or optical character recognition programs)—to determine a second common variable of the plurality of the enrollment processes that arose following completion of each of the enrollment processes. Further, the post-enrollment analysis agent may determine—for example, by inputting the database data into a machine learning program (and/or object recognition, facial recognition, or optical character recognition programs)—a correlation between the first common variable and the second common variable. Still further, the post-enrollment analysis agent may change at least one of pricing data and the configuration of the automated insurance enrollment program based upon the correlation.

The first common variable may be selected from a group consisting of: trusted transmission types, trusted transmission timing, trusted transmission combinations, vendor, pre-determined destination, and qualifying purchase type. The second common variable may be selected from a group consisting of rate of conversion to intended use and average realized risk reduction. The change in configuration of the automated insurance enrollment program and/or pricing data may consist of a change to at least one of: a discount amount, trusted transmission types, trusted transmission timing, trusted transmission combinations, vendor, pre-determined destinations, and qualifying purchase type.

For example, the first common variable may be a vendor consisting of a first third party vendor of alarm systems. The second common variable may be a rate of conversion to intended use consisting of a rate of consistent alarm monitoring. The correlation may consist of a showing that the rate of consistent alarm monitoring for alarm systems purchased from the first third party vendor is low. Preferably after the correlation is screened and vetted for reliability and consistency as described above, the post-enrollment analysis agent may change the configuration of the automated insurance enrollment program, for example by changing pre-determined destinations relied on during the automated enrollment process. The change may include a reduction in ranking for all pre-determined destinations associated with the first third party vendor.

For another example, the first common variable may be a qualifying purchase type consisting of an alarm system having basic security features. The second common variable may be an average realized risk reduction consisting of an average claim amount on property protected by the alarm system having basic security features. The correlation may consist of a showing that the average realized risk reduction for property protected by the alarm system having basic security features is low. Preferably after the correlation is screened and vetted for reliability and consistency as described above, the post-enrollment analysis agent may change the pricing data. The change may include a change to the discount amount offered for qualifying purchase of the alarm system having basic security features.

For yet another example, the first common variable may be a trusted transmission type consisting of a pre-enrollment sales receipt from a third party vendor verifying a qualifying purchase of an alarm system. The second common variable may be a rate of conversion to intended use consisting of a rate of consistent alarm monitoring. The correlation may consist of a showing that the rate of consistent alarm monitoring following verification through acceptance of the sales receipt is low. Preferably after the correlation is screened and vetted for reliability and consistency as described above, the post-enrollment analysis agent may change the configuration of the automated insurance enrollment program. The change may include changing the combination of trusted transmission(s) that may be considered acceptable for verifying a qualifying purchase. For example, the post-enrollment analysis agent may instruct a new requirement be added for a second verifying trusted transmission showing completion of alarm system installation.

### Exemplary Computer-Implemented Method

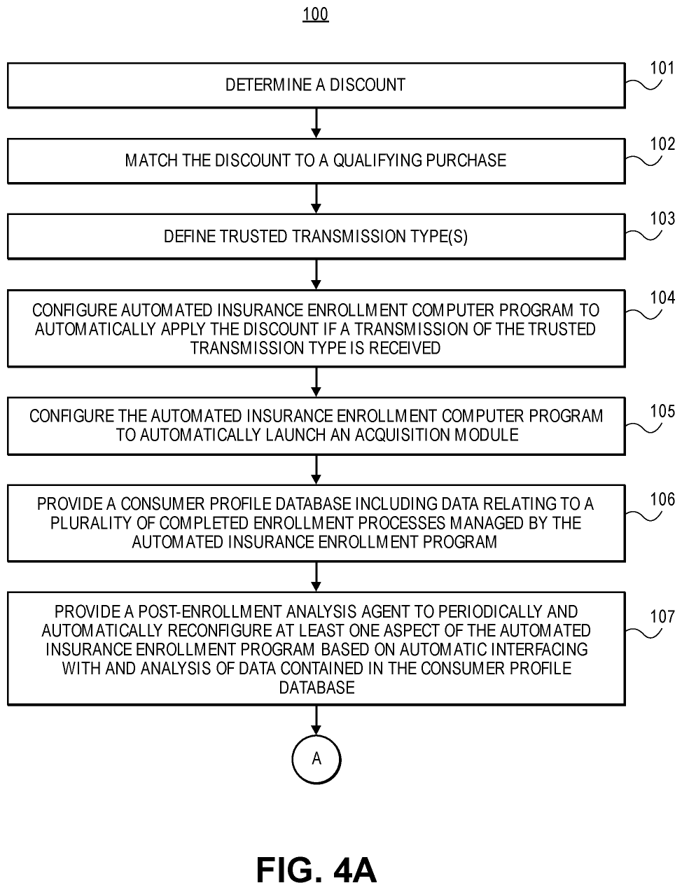

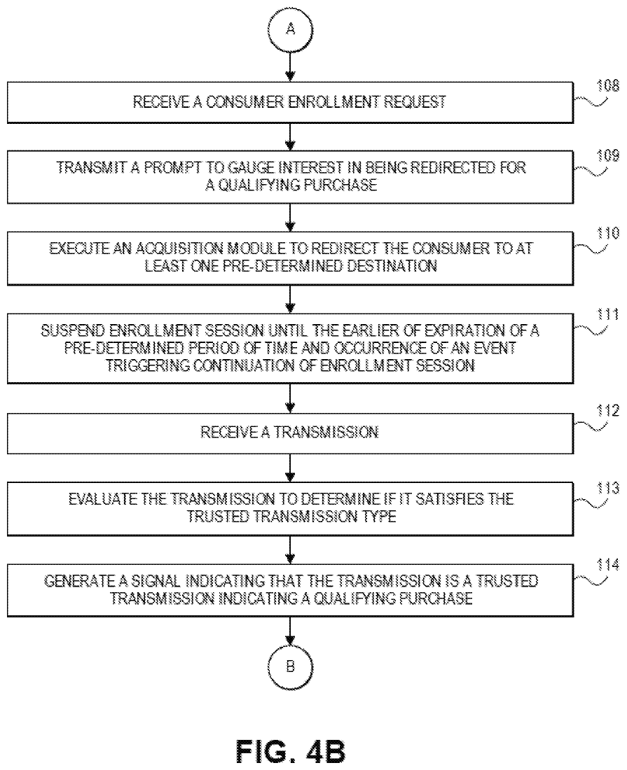

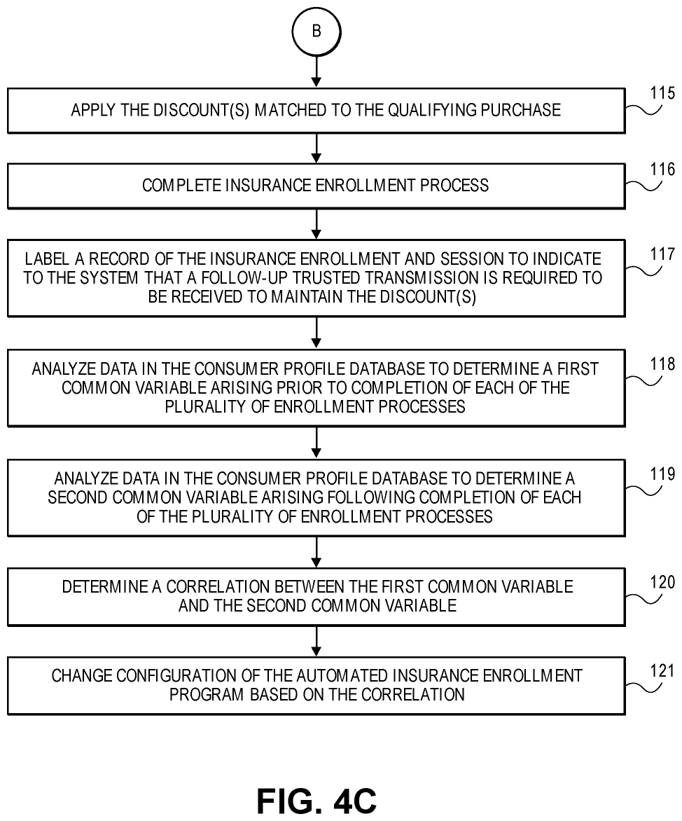

FIG. 4 depicts a listing of steps of an exemplary computer-implemented method 100 for coupling trusted transmission to automated insurance enrollment. The steps may be performed in the order shown in FIGS. 4A to 4C, or they may be performed in a different order. Furthermore, some steps may be performed concurrently as opposed to sequentially. In addition, some steps may be optional. The steps of the computer-implemented method 100 may be performed by the computer server 10.

Referring to step 101, a discount applicable to one or more insurance policies may be determined. The discount may be determined, for example, by reviewing competitor rates for analogous products and selecting a discount tending to bring the overall cost to the consumer to a competitive level. Referring to step 102, the discount may be matched to a qualifying purchase comprising a particular good or service likely to reduce risk to the insured property and/or overall risk to the insurance provider related to issuance of the policy(ies). It is foreseen that a qualifying purchase may first be selected, and a discount determined based upon the expected risk reduction benefits of the qualifying purchase, without departing from the spirit of the present inventive concept.

Referring to step 103, one or more trusted transmission type(s) may be defined based upon the discount and qualifying purchase(s) determined and matched in steps 101, 102. For example, if the qualifying purchase(s) are security-related products for protecting items of property covered by a proposed homeowners' insurance policy, and the discount is substantial, two trusted transmission types may be defined for use in verifying whether a consumer qualifies for the discount. For example, each trusted transmission type may define: timing and multiplicity of trusted transmission(s); an acceptable message security level (e.g., encrypted or un-encrypted); one or more trusted senders (e.g., as determined by associated Internet Protocol addresses and/or authentication techniques or the like); one or more document types, such as a receipt of purchase or down payment, required to verify the qualifying purchase, as well as the product description required to confirm the nature of the product/service purchased; where a transmission's contents must be processed by an OCR program, one or more requirements for either manual verification or for metadata provided by the sender confirming the transmission's contents, or the like.

The enrollment program (preferably its acquisition module) may evaluate a trusted transmission type according to a simple rule based upon the presence or absence of each characteristic—for example, a rule pursuant to which at least three of four enumerated characteristics must be present for acceptance of the transmission—or may comprise a weighted algorithm in which particularly strong showings on one or two characteristics indicating trustworthiness may overcome the absence of other characteristics. For example, a weighted algorithm may strongly value (or “weight”) verification of a trusted sender but weakly value the presence of encryption.

Further, trusted transmission types may vary within a particular enrollment process and across different enrollment processes managed by the enrollment program. For example, where a proposed homeowners' insurance policy enjoys a discount if a qualifying purchase is verified by first and second trusted transmission types, the types may be alike in many respects—for example with respect to message-level security required and/or acceptable trusted sender(s)—but may vary with respect to required timing and document contents. The first trusted transmission type may comprise any one of a number of documents acceptable to evidence a completed sale and that must be received prior to application of the discount. The second trusted transmission type may comprise any one of a number of documents acceptable to evidence completed installation of the security-related product on premises and that must be received within three weeks (or other time period) of completion of the enrollment process. In this manner, configuring pricing data in steps 101, 102 and configuring the enrollment program by defining the trusted transmission type(s) in step 103 prepare the enrollment program to conduct automated enrollment processes.

Returning to step 101 specifically, the assumed risk reduction benefits associated with a qualifying purchase may directly relate to the amount of discount offered for making a qualifying purchase. In turn, the assumed risk reduction benefits may be viewed quantitatively and/or qualitatively as varying with a number of underlying assumptions. The assumptions may include the risk-reducing effects expected from use of the particular qualifying product/service in one or more types of use or use patterns, such as occasional monitoring, consistent monitoring, or constant monitoring by an alarm system. The assumptions may also include an expected percentage of conversion from purchase to actual use, which may be correlated to sub-groups by separating by third party seller (e.g., Seller A products are most likely to be converted to actual constant uses), type of qualifying product/service (e.g., alarm systems are most likely to be converted to actual constant monitoring uses), or other groupings. The assumptions may also include an expected rate of fraudulent submission at least partly correlated against trusted transmission type(s) and/or patterns. It is foreseen that other assumptions that may reasonably be related to a perceived risk reduction may be employed to inform the process of determining a discount, without departing from the spirit of the present inventive concept.

It is foreseen that steps 101-103 may also be performed by inputting data into a trained machine learning program—including as described below in connection with operation of the post-enrollment analysis agent—to determine the discount, match the discount to at least one qualifying purchase, and/or define trusted transmission type(s), without departing from the spirit of the present inventive concept. Such data may include data regarding market trends, data regarding underlying process-related assumptions and trends, and other factors traditionally effecting premium determination.

Referring to step 104, an enrollment program may be configured to automatically apply the discount based upon receipt of at least one transmission of the trusted transmission type(s) defined at step 103. The enrollment program may be configured to apply the discount upon receipt and verification of the transmission's contents (e.g., using OCR techniques and/or metadata or structured data fields), following a delay, upon another event that must follow receipt of a first trusted transmission (such as receipt of a second trusted transmission), or may be otherwise configured to trigger application of the discount.

Referring to step 105, the enrollment program may be configured to automatically launch an acquisition module. The acquisition module may be automatically launched upon receipt of an affirmative prompt response from the consumer as described in additional detail below, or may be launched according to another pre-determined sequence of event(s), without departing from the spirit of the present inventive concept. Preferably, configuring the acquisition module includes providing a file containing a list of pre-determined destinations for the acquisition module to interface with, and from which the acquisition module may extract one or more pre-determined destinations to offer a consumer and/or to redirect the consumer to a qualifying purchase. The list of pre-determined destinations may be prioritized, organized and/or populated by inputting data regarding a plurality of vendors into a trained machine learning program, including as described below in connection with operation of the post-enrollment analysis agent. The list of pre-determined destinations may be continually updated manually and/or through interfacing with third party websites containing seller reviews or similar rankings commonly employed in e-commerce sales platforms. It is also foreseen that the list may be hosted and/or managed by such third party websites without departing from the spirit of the present inventive concept.

Referring to step 106, a consumer profile database may be provided including data relating to a plurality of completed enrollment processes managed by an automated insurance enrollment program. Preferably, in each such completed enrollment process, the automated insurance enrollment program will have executed an acquisition module and verified a qualifying purchase using a trusted transmission prior to completion. Each of these actions, together with associated metadata and copies of documents exchanged and submitted, are preferably stored within the consumer profile database. Other information generated through interactions with the consumer(s) may be stored in the customer profile database, such as submitted claims under the issued policy(ies) and/or post-enrollment transmissions.

In addition, the enrollment program preferably is configured to gather as much basic information regarding the consumer as possible from accessible databases—for example the consumer's age, income level, family status, residence, history of insurance claims, and other risk factors relating to the insurance type the consumer is seeking—and to prompt the consumer to provide pertinent information that may be missing from such databases. This collection of basic, insurance-related information regarding the consumer that is accessible to the enrollment program may be saved in the consumer profile database, which may be updated from time to time including as a result of enrollment process(es), receipt of post-enrollment transmissions, occurrence of qualifying purchase(s) and/or filing of insurance claims. The consumer profile database may also be supplemented using sources of public information, such as news outlets and/or criminal record databases, without departing from the spirit of the present inventive concept.

Referring to step 107, a post-enrollment analysis agent may be provided for periodically and automatically reconfiguring at least one aspect of an automated enrollment program based upon automatic interfacing with and analysis of data contained in the consumer profile database. The automated enrollment program is preferably based upon and/or is a derivate version of the program that managed the completed enrollment processes populating the consumer profile database. However, it is foreseen that even data collected in association with enrollment processes managed by significantly different automated programs may be useful in illuminating correlations that may be analyzed by the post-enrollment analysis agent, without departing from the spirit of the present inventive concept. The operation of the post-enrollment analysis agent will be discussed in greater detail below.

Referring to step 108, a consumer enrollment request may be received, for example via wireless communication and using one or more radio links between devices, by the enrollment program. More particularly, the insurance enrollment program is preferably triggered to begin or continue the enrollment process when it receives a consumer-generated enrollment request—for example a consumer-generated mouse input associated with selection of an option for proceeding with enrollment at a user interface.

Optionally, a prompt may be generated and/or transmitted to the consumer, such as via wireless communication and using one or more radio links between devices, inquiring about whether the consumer already possesses or enjoys a qualifying product/service. The prompt may appear in a pop-up window or as part of a list or sequence of questions on a regular page of the website. The prompt may include questions regarding the home or other to-be-insured property. The prompt may also or alternatively provide information to the consumer. The prompt may ask the consumer if they have recently purchased and installed/used any safety, health and/or security-related products, services and/or devices. These products may include a security system, fire alarms, fire extinguishers, sprinklers, dead bolt locks, health monitoring devices, car alarms, or other qualifying products/services. Another prompt may be generated and/or transmitted, such as via wireless communication and using one or more radio links between devices, that asks the consumer about architectural or structural features of the house such as the type of material used for the roof of the house, whether renovations, such as remodeling or adding on to the house, have been made recently (within the past year), and so forth.

If the consumer answers yes to the purchase and/or installation of any safety, health and/or security-related products, specifies that impact-resistant material has been used on the roof or that renovations have recently been done, or otherwise indicates that a qualifying product/service has been obtained and/or is being used, another prompt may be transmitted, for example over one or more radio links, for the consumer to grant permission to the insurance provider to request information from the relevant third party. For example, if the consumer responded that their house includes one or more of the safety and security products, the prompt may ask the consumer to provide contact information about the vendor who sold the safety or security product, and to grant permission to contact the vendor. After receiving permission, the vendor may be contacted to request documents that provide a proof of purchase, such as an invoice or a sales receipt. Alternatively or additionally, if the consumer specifically responded that their house includes one or more of the qualifying products/services, then another prompt may be generated to ask the consumer to provide contact information about the contractor who installed the product, and to grant permission to contact the contractor. After receiving permission, the contractor may be contacted to request documents, such as an invoice or receipt for the installation, or a statement from the contractor attesting that he installed the safety or security product.

Referring to step 109, a prompt may be generated and/or transmitted, such as via wireless communication and using one or more radio links between devices, to the consumer. The enrollment program may access the qualifying product(s)/service(s) matched at step 102 to generate the prompt to inform the consumer that they may be eligible for a discount on their insurance premium (such as homeowners, renters, personal articles, or auto insurance) if they purchase and/or install and/or use the qualifying product(s)/service(s). For example, the qualifying product(s)/service(s) may include a security system with specific features, or certain security system models that qualify for the discount, types of door locks, types of fire alarms, fire extinguishers, and sprinklers, and so forth. Preferably, an option to be redirected to at least one destination, such as one or more webpage(s) or mobile application(s), is presented to the consumer within the prompt. Preferably, the prompt, its contents and delivery, are managed at least in part by an acquisition module.

Each destination offered to the consumer by the acquisition module preferably provides information relating to and/or means to complete at least one qualifying purchase for one or more discount(s) offered by the insurance provider. For example, the consumer may be offered a list of websites for vendors that sell and/or lease such qualifying product(s)/service(s). The consumer may also or alternatively be offered a list of qualifying product(s)/service(s) and/or groupings thereof from which the consumer can choose. The destinations offered to the consumer and their order/prioritization may be chosen by the acquisition module based upon commonly-employed prioritization techniques, for example by taking into account consumer or industry reviews and ratings, breadth of product offerings, price competitiveness, and other aspects of the product(s)/service(s) and/or vendors that commonly govern in analogous e-commerce applications.

Referring to step 110, if a consumer responds affirmatively to the prompt, for example by selecting one or more product(s), service(s) and/or vendor(s) or otherwise expressing interest in a qualifying purchase, the acquisition module may be executed in whole or in part to redirect the consumer to at least one pre-determined destination. The destination(s) may be operated and/or hosted by a third party, for example a third party vendor, or by an insurance provider server.

Referring to step 111, in some embodiments, the enrollment session the consumer is participating in may be suspended following redirection by the acquisition module. Suspending the enrollment session may include automatically saving all information gathered to that point in the enrollment process and/or flagging digital files associated with the enrollment process so they are readily retrievable when one or more events occur to signal the enrollment process has again become active. For example, the session may be suspended until the earlier of expiration of a pre-determined period of time and occurrence of an event triggering continuation of the enrollment session.

Referring to step 112, a transmission may be received by the enrollment program. Information regarding the transmission(s) may be provided in metadata associated with the transmission(s), may be extracted through optical character recognition, or may be obtained through other known means of retrieving similar information. For example, the transmission may include an image of a receipt evidencing completion of a qualifying purchase. Information regarding same may be obtained by recognizing metadata summarizing the contents of the receipt, or may be extracted through execution of optical character recognition software. The information obtained may include which product(s) or service(s) the transmissions relate to and whether such product(s) or service(s) are “qualifying” in any respect, for example by comparison against a list of discount—product/service pairings included in pricing data. Such information may also include one or more consumers associated with the purchase(s), for example as identified through explicit identification/means of submission by the third party vendor originating the transmission or from information recognition and extraction procedures identified above. The information may further include pending enrollment process(es), from enrollment records, of identified consumers that may be affected by the information obtained from the transmission.

Referring to step 113, the information regarding the transmission may be evaluated to determine if it satisfies one or more of the trusted transmission type(s). Where the transmission does not satisfy a trusted transmission type, the insurance enrollment program preferably sends a notification to the affected consumer(s) notifying them that a transmission was received regarding a potential qualifying purchase, but that the discount was not authorized based upon the transmission. The notification may also include suggested “next steps” the consumer(s) might take to generate a transmission that might address the failure of authorization or to otherwise attain the discount in question.

Referring to step 114, where the transmission does satisfy a trusted transmission type, the enrollment program may generate a signal to the enrollment program indicating that the transmission is a trusted transmission verifying a qualifying purchase. The signal may comprise an instruction to store in memory that the transmission satisfied at least one trusted transmission type.

Referring to step 115, the enrollment program may apply the resulting discount(s) to the implicated pending enrollment process(es) and notify the affected consumer(s) of same. The enrollment program may also periodically check the status of pending enrollment processes, for example following success or failure of a transmission to meet “trusted” criteria, to determine whether the enrolling consumer(s) have reached final disposition on all indications of interest in making qualifying purchases. The enrollment program may also check the customer profile database to determine whether any of the indications of interest are aged, and/or if a certain number of transmissions have failed to receive “trusted” status to allow a discount to be applied.

Referring to step 116, the enrollment program may prompt the user to complete the pending enrollment process, or may instruct the automatic completion of the enrollment process, based upon application of the discount, the preferences of the user and the status of all outstanding indications of interest in making qualifying purchases. For example, a consumer may have indicated an interest in pursuing three qualifying purchases in connection with discounts for a policy under a pending enrollment process. The consumer may have completed one qualifying purchase that has been verified by the trusted transmission, with a discount having been applied as a result thereof, but the other two qualifying purchases for which interest was expressed are deemed “aged” through lack of related activity over several weeks. In such cases, the enrollment program may prompt the user to complete the pending enrollment process on the basis of the discount that was applied. Preferably, the user enrollment request is received, the qualifying purchase is completed and confirmed by the trusted transmission, and the enrollment process is completed, all in the same enrollment session.

Following completion of an enrollment process, the enrollment program may close the associated enrollment record, though it may be periodically re-opened and/or associated with other records reflecting post-enrollment activities such as submission of claims and/or additional transmissions. Referring to step 117, the enrollment program may associate an additional contingency with such an enrollment record. The additional contingency may be required for maintaining a discount applied during the pendency of the enrollment process. For example, a homeowner's insurance policy may have had a discount applied for qualifying purchase and use of a security alarm. The discount may be initially applied based upon a first trusted transmission satisfactorily evidencing the qualifying purchase. The additional contingency may, however, require receipt of a post-enrollment, second trusted transmission from a contractor evidencing installment of the alarm system and/or from a monitoring service provider evidencing that the system is regularly being put to use. In some cases, such as where the discount and/or additional contingency requires proof of consistent use of a qualifying product or service, the first and/or second trusted transmission may be received from a smart home controller or telematics data device, without departing from the spirit of the present inventive concept.

The additional contingency may be time sensitive (e.g., transmission confirming installation must occur within one month or the discount will be withdrawn), or event based (e.g., an additional discount will be applied upon receipt of evidence from a monitoring service provider showing consistent use at a certain level). Based upon the type of additional contingency, the enrollment program may cause application of such discount changes and/or generate notifications to the consumer(s) regarding same on a periodic or event-based schedule.

It is also preferable to deploy a post-enrollment analysis agent for use in conjunction with the enrollment program to provide an improved method of coupling trusted transmissions to the automated enrollment process. The post-enrollment analysis agent may be executed independently from the standard routines of the enrollment program that manage the enrollment process, in order that the agent may independently monitor, evaluate, and adjust the parameters of the enrollment program and/or the values stored in system databases. The post-enrollment analysis agent may monitor and evaluate pre-enrollment and post-enrollment activities relating to consumers' insurance policies.

The post-enrollment analysis agent may interface with the consumer profile database. Specifically, the post-enrollment analysis agent preferably has access to claims information and post-enrollment transmissions, as well as to a variety of other information gathered into the consumer profile database by the enrollment program, as described in additional detail above. Additionally, the post-enrollment analysis agent should have access to basic information gathered during the pendency of enrollment processes. For example, the consumer profile database may contain information regarding: consumers, gathered through and/or in connection with enrollment processes managed by the automated insurance enrollment program, and with the consumers' permission; user selections made during such enrollment processes; conclusions/selections arrived at by the insurance enrollment program throughout such enrollment processes; trusted transmissions received during and after completion of such enrollment processes; vendors and/or pre-determined destinations presented to and/or selected by consumers; qualifying purchases and/or qualifying products/services presented to and/or selected by consumers; location-based facts pertinent to risk analyses for areas policies are issued in connection with; claims entered in connection with insurance policies, and other pertinent information.

Referring to step 118, the post-enrollment analysis agent may periodically access the consumer profile database to determine a first variable common to a plurality of enrollment processes that arose prior to their completion. Referring to step 119, the post-enrollment analysis agent may also determine a second variable common to the plurality of enrollment processes that arose following their completion. Preferably, the post-enrollment analysis agent is initially provided a set of possible first common variables along with a set of possible second common variables, together with a relational data set identifying or mapping known correlations between first and second common variables and/or groups of first common variables and groups of second common variables. These variable and relational data sets may be updated from time to time by system administrators and/or through machine-learning techniques discussed in further detail below.

Referring to step 120, following selection of a first common variable and a second common variable, a correlation between the first common variable and the second common variable may be determined. For example, where a particular qualifying product, service, vendor or trusted transmission contributed to application of a discount prior to completing enrollment, it may be determined that an uncharacteristically low rate of conversion to intended use and/or realized risk reduction is realized by such consumers. Based thereon, the post-enrollment analysis agent may determine that the risk-reduction benefit assumptions underlying the applied discount no longer hold true. However, any correlation identified by the post-enrollment analysis agent is preferably screened before such a conclusion is reached, for example to ensure that the sample size is sufficient, the correlation is sufficiently longstanding, the standard deviation is sufficiently minimal, and that other similar indicators of accuracy are present.

Where the exemplary correlation described above has been found, screened and vetted for reliability and accuracy, the post-enrollment analysis agent may reduce the discount amount represented in pricing data relied on by the insurance enrollment program. Referring to step 121, the post-enrollment analysis agent may also or alternatively reconfigure the enrollment program by: changing trusted transmission type(s) permitted to verify qualifying purchase(s); changing the timeframes in which and/or periodicity with which trusted transmissions are required to be provided/confirmed; changing the number of trusted transmissions that are required to be provided/confirmed; adding/removing/re-ordering vendor and/or pre-determined destination listings used by the acquisition module to redirect users; changing the qualifying purchase(s), and making other similar changes that may be expected to lead to completed enrollment processes reflective of the risk likely to be experienced by the insurance provider.

### Exemplary Computer-Readable Medium for Coupling Trusted Transmissions to Automated Insurance Enrollment

In another aspect, a computer-readable medium for coupling trusted transmissions to automated insurance enrollment may be provided. The computer-readable medium may include an executable program stored thereon, wherein the program instructs a processing element of a computer server to perform the following: (1) receive a consumer enrollment request; (2) transmit a prompt to be presented on a computing device display to gauge whether the consumer is interested in being redirected for consideration of at least one qualifying purchase linked to at least one discount; (3) receive an affirmative response to the prompt; (4) redirect the consumer to information relating to the at least one qualifying purchase via acquisition module; (5) receive a trusted transmission of a trusted transmission type, the trusted transmission indicating that a qualifying purchase is or will be made by the consumer; and (6) apply a discount linked to the qualifying purchase before completing the insurance enrollment. The one or more pre-determined destinations may comprise at least one of (i) a webpage, (ii) a mobile application. The program stored on the computer-readable medium may instruct the processing element to perform additional, fewer, or alternative actions, including those discussed elsewhere herein.

For instance, the program may instruct the processing element to: execute the acquisition module to redirect a consumer to one or more pre-determined destinations selected to enable the consumer to perform at least one of the following: (A) select a vendor from which to make a qualifying purchase, and (B) make a qualifying purchase. The program may also instruct the processing element to complete each of the following within the same enrollment session: receive the consumer enrollment request, confirm the qualifying purchase was completed based upon at least the trusted transmission, and complete the insurance enrollment.

### Exemplary Computer Server for Coupling Trusted Transmissions to Automated Insurance Enrollment

In another aspect, a computer server for coupling trusted transmissions to automated insurance enrollment may be provided. The computer server may include a communication element, a memory element, and a processing element. The communication element may receive and transmit communications to and from a plurality of computing devices. The memory element may be electronically coupled to the communication element and may store executable instructions. The processing element may be electronically coupled to the communication element and the memory element. The processing element may be configured to (1) receive a consumer enrollment request; (2) transmit a prompt to be presented on a computing device display to gauge whether the consumer is interested in being redirected for consideration of at least one qualifying purchase linked to at least one discount; (3) receive an affirmative response to the prompt; (4) redirect the consumer to information relating to the at least one qualifying purchase via acquisition module; (5) receive a trusted transmission of a trusted transmission type, the trusted transmission indicating that a qualifying purchase is or will be made by the consumer; and (6) apply a discount linked to the qualifying purchase before completing the insurance enrollment. The one or more pre-determined destinations may comprise at least one of (i) a webpage, (ii) a mobile application. The computer server may include additional, fewer, or alternate components and/or functionality, including that discussed elsewhere herein.

For instance, the processing element may be further configured to: redirect a consumer to one or more pre-determined destinations selected to enable the consumer to perform at least one of the following: (A) select a vendor from which to make a qualifying purchase, and (B) make a qualifying purchase. The processing element may also be configured to complete each of the following within the same enrollment session: receive the consumer enrollment request, confirm the qualifying purchase was completed based upon at least the trusted transmission, and complete the insurance enrollment.

### Additional Exemplary Computer-Implemented Methods

In one aspect, a computer-implemented method of coupling trusted transmissions to automated insurance enrollment may be provided. The method may include: (1) determining a discount; (2) matching a qualifying purchase with the discount; (3) defining at least one trusted transmission type indicative of the qualifying purchase; and/or (4) configuring an automated insurance enrollment computer program to automatically apply the discount if a transmission of the at least one trusted transmission type is received. The automated insurance enrollment computer program may be further configured to automatically receive consumer enrollment selections over a communication network and to automatically complete an enrollment process based upon the enrollment selections and on pricing data stored in a memory device.

In another aspect, a computer-implemented method of coupling trusted transmissions to automated insurance enrollment may be provided. The method may include determining a qualifying purchase matched to a discount and configuring an automated insurance enrollment computer program to automatically launch an acquisition module, the acquisition module being configured to assist the consumer in making the qualifying purchase. The automated insurance enrollment computer program may be further configured to: (1) automatically receive, over a communication network, consumer enrollment selections and at least one trusted transmission of a trusted transmission type indicative of the qualifying purchase, and (2) automatically complete an enrollment process based upon the enrollment selections, the trusted transmission, and on pricing data stored in a memory device.

The foregoing methods may include additional, less, or alternate actions, including those discussed elsewhere herein. The foregoing methods may be implemented via one or more local or remote processors and transceivers, and/or via computer-executable instructions stored on non-transitory computer-readable media or medium.

### Exemplary Home Alert Cross-Sell Method

The present embodiments may provide lower up-front pricing, lower risk exposure for insurance providers, and better sales conversion rates as a result of finding a way to provide a “Home Alert” or home security system discount more easily to customers, such as within an online acquisition processes.

A computer-implemented method may couple the online sale of a Home Alert system and service subscription with the online homeowners insurance acquisition process. When an online customer does not already qualify for this discount, the un-discounted quoted premium may be connected to messaging that provides the specific premium discount related to Home Alert. Further, this virtual messaging may prompt a customer to purchase a qualifying Home Alert system (in the same online process). The exact savings per type of Home Alert system may be pre-calculated, such that adding a specific type of device may be tied to a tiered discount (e.g., purchasing a Nest system may result in $100 annual insurance premium savings, purchasing a cell application phone-based alert system may result $50 annual insurance premium savings, etc.). If such a system is purchased within the homeowners insurance acquisition process, the discount may be immediately applied to the purchase (rather than pending future documentation).

The information necessary to complete the sale of the Home Alert system and service may be communicated from the homeowners insurance process directly to the 3^{rd} party provider (e.g., customer name, customer phone, customer email, risk location address, payment information, etc.). In lieu of supporting documents from customers, an information sharing authorization may be indicated by the customer, allowing the provider of the Home Alert system/service to communicate confirmation of installation directly to the insurance provider.

Further, the display of available/qualifying systems presented to a customer during the online homeowners insurance acquisition process may be modulated according to various parameters, such as available vendors, qualifying systems per vendor, the insurance provider's or customer's preferred price range per system, the insurance provider's or customer's preferred particular systems/services (i.e., that correspond to a preferred set of options among available systems from one or more preferred vendors), and the product involved (i.e., different systems suggested, based on whether the product being purchased is related to providing security for home, apartment, condo, or commercial building).

Future enhancements could contemplate increased rating sophistication, such that the current home security discount of a given percentage may be modulated according to the variation in risk reduction corresponding with particular security systems/services. For example, a cell phone-based burglar alarm may result in a 2% discount, an automated deadbolt system may result in a 5% discount, and a comprehensive home automation system may result in a 15% discount. Integration of the sale of a risk-reducing and price-reducing product/service into the insurance acquisition process may be provided. Also, substitution of 3^{rd} party product/service sale for traditional supporting documentation requirements related to home security system discounts may be provided.

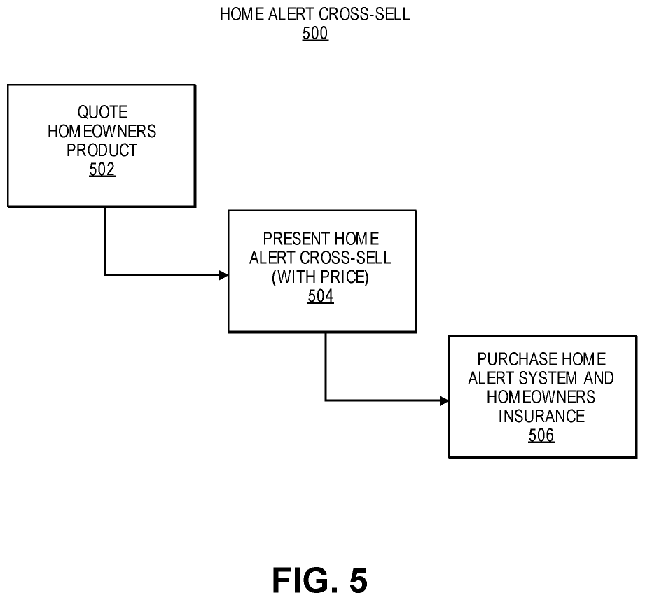

FIG. 5 depicts an exemplary computer-implemented home alert cross-sell method 500. An online customer may be asking for a virtual quote for an insurance product (such as homeowners, renters, or condo insurance). The insurance provider website or remote server may obtain the necessary information, and generate a virtual homeowners quote and display that quote to the customer via the website 502.

The insurance provider website remote server may recognize that the customer currently does not have a home or other security system for the asset to be insured (such as if the customer is an existing customer), or the website may ask the customer whether they have a home security system, and the customer may indicate that they do currently have a security system installed. If so, the insurance provider remote server may estimate an insurance discount if the customer were to purchase and/or install a home or other security system. The method 500 may include presenting the Home Alert cross-sell opportunity (with the amount of insurance discount and the price of the security system) to the customer via the website 504. For instance, the website may indicate to the customer that if they purchase a security system online, they are entitled to a discount of a given percentage on their home or renters insurance. The lower price for the insurance product may be priced or quoted in real-time or near real-time, and may be immediately actionable or binding if the online customer agrees to the purchase and installation of the security system, or otherwise gives their affirmative consent.

The method 500 may include the combined purchase of the home alert or other security system, along with insurance, such as homeowners or renters insurance 506. For instance, the insurance provider website or remote server may indicate to the customer that if they purchase the security system indirectly (or directly) via the insurance provider website, that they will immediately receive a credit or discount on their corresponding insurance product, and that the insurance provider will, with the customer's permission or affirmative consent, follow-up directly with the vendor or security system supplier/manufacturer at a later date to verify installation and/or that the security system is working properly. Thus, in some instances, the method 500 may alleviate the need for an insurance representative or agent to follow-up with the customer and substantiate the discount. The method 500 may include additional, less, or alternative actions, including that discussed elsewhere herein, and/or may be implemented via one or more local or remote processors and transceivers, and/or via computer-executable instructions stored on computer-readable medium.

In one aspect, a computer-implemented of method of cross-selling a security system with insurance, or otherwise facilitating the sale of a security system may be provided. The method may include (1) receiving, via one or more processors and/or transceivers over one or more radio links (and/or via wireless communication or data transmission), a request for a quote for homeowners insurance or other insurance covering a dwelling or building, and information about the dwelling (or building); (2) generating, via one or more processors, the requested insurance quote covering the dwelling; (3) determining or recognizing, via the one or more processors, whether or not the dwelling has a security system installed; (4) if not, calculating, via the one or more processors, a price for a security system and an associated insurance discount for the customer if they decide to purchase and install the security system; (5) transmitting the requested insurance quote, the price for the security system, and insurance discount associated with security system installation, via the one or more processors and/or transceivers, to a mobile device of the customer for their review, modification, or approval; (6) receiving, via the one or more processors and/or transceivers, an customer indication that they would like to purchase the security system and receive the insurance discount immediately; (7) redirecting, via the one or more processors and/or transceivers, to a portal that allows the customer to purchase the security system in a secure and online manner; (8) receive, via the one or more processors and/or transceivers, verifying electronic documents that they have purchased the security system online directly from the customer's mobile or other computing device; and/or (9) immediately binding, via the one or more processors and/or transceivers, the insurance product covering the dwelling with the discount associated with the security system being applied to facilitate providing insurance customers with homeowners or renters insurance discounts associated with installation of security systems. The method may include additional, less, or alternate actions, including those discussed elsewhere herein.

In another aspect, a computer system configured to cross-sell a security system with insurance, or otherwise facilitate the sale of a security system may be provided. The computer system may include one or more processors and/or transceivers configured to: (1) receive over one or more radio links (and/or via wireless communication or data transmission) a request for a quote for homeowners insurance or other insurance covering a dwelling or building, and information about the dwelling (or building); (2) generate the requested insurance quote covering the dwelling; (3) determine or recognize whether or not the dwelling has a security system installed; (4) if not, calculate a price for a security system and an associated insurance discount for the customer if they decide to purchase and install the security system; (5) transmit the requested insurance quote, the price for the security system, and insurance discount associated with security system installation to a mobile device of the customer for their review, modification, or approval; (6) receive a customer indication that they would like to purchase the security system and receive the insurance discount immediately; (7) redirect to a portal that allows the customer to purchase the security system in a secure and online manner; (8) receive verifying electronic documents that they have purchased the security system online directly from the customer's mobile or other computing device; and/or (9) immediately bind the insurance product covering the dwelling with the discount associated with the security system being applied to facilitate providing insurance customers with homeowners or renters insurance discounts associated with installation of security systems. The computer system may include additional, less, or alternate functionality, including that discussed elsewhere herein.

### Additional Considerations

With the foregoing, an insurance consumer may opt-in to an insurance discount through completing a qualifying purchase. After the insurance consumer provides their affirmative consent, an insurance provider telematics application and/or server may collect smart home, mobile device, vehicle, telematics and/or other data (including image or audio data) associated with the qualifying product/service and/or insured property, including before, during, and/or after an insurance-related event. In one aspect, sensor or other data may be collected or received by an insured's smart home, mobile device or smart vehicle, a 3rd party service provider, and/or an insurance provider remote server, such as via direct or indirect wireless communication or data transmission from an application running on the insured's smart home controller, mobile device or vehicle, or 3rd party remote server, after the insured or consumer affirmatively consents or otherwise opts-in to an insurance discount program. The insurance provider may then analyze the data received with the consumer's permission to determine whether the terms and contingencies attached to the discount are being and/or have been fulfilled. As a result, risk-averse consumers may receive insurance discounts or other insurance cost savings based upon functionality and/or technology discussed herein that may mitigate or prevent risk to (i) insured assets, such as homes, apartments, personal articles, or vehicles, and/or (ii) insureds and family members caused by insurance-related events.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A computer-implemented method for processing insurance enrollments using trusted transmissions, the method comprising:
receiving, by a server from a computing device, an enrollment request to complete an insurance enrollment process from a consumer;
transmitting, by the server to the computing device, a prompt to be presented on a display of the computing device that asks if the consumer is interested in considering at least one qualifying purchase linked to at least one discount;
receiving, by the server from the computing device, a response indicating that the consumer answered affirmatively to the prompt;
in response to receiving a response indicating that the consumer answered affirmatively to the prompt,
launching an acquisition module, by the server, to extract one or more destinations based on the enrollment request;
transmitting, by the server to the computing device, instructions that cause the computing device to redirect to at least one of the one or more destinations for information relating to the at least one qualifying purchase linked to the at least one discount;
receiving, by the server from the computing device, a first trusted transmission, the first trusted transmission indicating that the at least one qualifying purchase is or will be made by the consumer;
identifying a trusted transmission type based at least in part upon the enrollment request and the consumer, the trusted transmission type comprising a set of transmission characteristics, the set of transmission characteristics comprising at least one of a transmission source, a transmission security level, a type of an event signified by information transmitted, and a type of a document being transmitted;
evaluating whether the first trusted transmission satisfies the trusted transmission type based upon a rule associated with the trusted transmission type, the rule using the set of transmission characteristics of the trusted transmission type; and
in response to the trusted transmission satisfying the trusted transmission type,
transmitting, by the server to the computing device, a notification to be presented on the display of the computing device that indicates the at least one discount has been applied to the at least one qualifying purchase before completing the insurance enrollment process; and
receiving, by the server from the computing device, a second trusted transmission, the second trusted transmission verifying that an additional contingency of the at least one qualifying purchase has been performed to confirm application of the at least one discount to the at least one qualifying purchase after completing the insurance enrollment process.

2. The computer-implemented method of claim 1, wherein the instructions that cause the computing device to redirect the consumer are configured to redirect the consumer to one or more pre-determined destinations selected to enable the consumer to perform at least one of: (A) select a vendor from which to make the least one qualifying purchase, and (B) make the least one qualifying purchase.

3. The computer-implemented method of claim 2, wherein the one or more pre-determined destinations are operated by at least one third party vendor.

4. The computer-implemented method of claim 2, wherein the one or more pre-determined destinations comprise at least one of: (i) a webpage, or (ii) a mobile application.

5. The computer-implemented method of claim 1, wherein the insurance enrollment process comprises a change in scope for an existing insurance coverage.

6. The computer-implemented method of claim 1, wherein the insurance enrollment process includes an acquisition of an insurance coverage.

7. The computer-implemented method of claim 1, wherein the trusted transmission type is at least one of: (1) a transmission containing a receipt for the at least one qualifying purchase, (2) a transmission containing an invoice for the at least one qualifying purchase, (3) a transmission confirming the consumer is obligated to complete or has completed the at least one qualifying purchase, or (4) a transmission confirming delivery of a product and/or service acquired by the consumer through the at least one qualifying purchase.

8. The computer-implemented method of claim 7, wherein the trusted transmission type further includes specification of at least one trusted sender.

9. The computer-implemented method of claim 1, wherein completing the insurance enrollment process includes making the at least one qualifying purchase and confirming that the at least one qualifying purchase has been made by the first trusted transmission.

10. The computer-implemented method of claim 9, wherein completing the insurance enrollment process further includes labeling a record of the insurance enrollment process to indicate that the second trusted transmission is of a second trusted transmission type and must be received to confirm the application of the at least one discount.

11. The computer implemented method of claim 10, wherein the second trusted transmission type is a transmission from a product acquired by the consumer through the at least one qualifying purchase.

12. The computer-implemented method of claim 10, wherein the second trusted transmission type includes a time period in which the second trusted transmission must be received.

13. The computer-implemented method of claim 11, wherein the second trusted transmission is received from a smart home controller.

14. The computer-implemented method of claim 11, wherein the second trusted transmission is received from a telematics device installed in a vehicle.

15. The computer-implemented method of claim 1, wherein the insurance enrollment process is suspended at least once after the consumer is redirected and before the first trusted transmission is received.

16. The computer-implemented method of claim 1, wherein the prompt includes a list of goods and/or services.

17. The computer-implemented method of claim 1, wherein the prompt includes a list of possible discounts.

18. The computer-implemented method of claim 1, wherein the first trusted transmission is received from a smart home controller.

19. The computer-implemented method of claim 1, wherein the first trusted transmission is received from a telematics device installed in a vehicle.

20. The computer-implemented method of claim 1, further comprising, prior to receiving the enrollment request:
using machine learning to determine an average realized risk reduction based on historical data related to the at least one qualifying purchase;
defining the at least one discount based on the average realized risk reduction;
matching the at least one discount to the at least one qualifying purchase; and
defining the trusted transmission type.

21. A computer server for processing insurance enrollments using secure transmissions, the computer server comprising:
a processor; and
a memory storing executable instructions that, when executed by the processor, cause the processor to:
receive, from a computing device, an enrollment request to complete an insurance enrollment process from a consumer;
transmit, to the computing device, a prompt to be presented on a display of the computing device that asks if the consumer is interested in considering at least one qualifying purchase linked to at least one discount;
receive, from the computing device, a response indicating that the consumer answered affirmatively to the prompt;
in response to receiving a response indicating that the consumer answered affirmatively to the prompt,
launch an acquisition module to extract one or more destinations based on the enrollment request;
transmit, to the computing device, instructions that cause the computing device to redirect to at least one of the one or more destinations for information relating to the at least one qualifying purchase linked to the at least one discount;
receive, from the computing device, a first trusted transmission, the first trusted transmission indicating that the at least one qualifying purchase is or will be made by the consumer;
identify a trusted transmission type based at least in part upon the enrollment request and the consumer, the trusted transmission type comprising a set of transmission characteristics, the set of transmission characteristics comprising at least one of a transmission source, a transmission security level, a type of an event signified by information transmitted, and a type of a document being transmitted;
evaluate whether the first trusted transmission satisfies the trusted transmission type based upon a rule associated with the trusted transmission type, the rule using the set of transmission characteristics of the trusted transmission type; and
in response to the first trusted transmission satisfying the trusted transmission type,
transmit, to the computing device, a notification to be presented on the display of the computing device that indicates the at least one discount has been applied to the at least one qualifying purchase before completing the insurance enrollment process; and
receive, from the computing device, a second trusted transmission, the second trusted transmission verifying that an additional contingency of the at least one qualifying purchase has been performed to confirm application of the at least one discount to the at least one qualifying purchase after completing the insurance enrollment process.
